(19) United States
(12) Patent Application Publication
(10) Pub. No.: US 2026/0353302 A1
(43) Pub. Date: Nov. 5, 2026

(54) METHODS FOR MULTIVIEW LEARNING FOR OPTIMIZED UPLINK POWER CONTROL

(71) Applicant: InterDigital Patent Holdings, Inc., Wilmington, DE (US)

(72) Inventors: Mohamed Salah Ibrahim, Chesterbrook, PA (US); Yugeswar Deenoo Narayanan Thangaraj, Chalfont, PA (US); Mihaela Beluri, Jericho, NY (US); Ahmet Serdar Tan, London (GB)

(73) Assignee: InterDigital Patent Holdings, Inc., Wilmington, DE (US)

(21) Appl. No.: 19/198,877

(22) Filed: May 5, 2025

(51) Int. Cl. H04W 52/14

(52) U.S. Cl. CPC H04W 52/146

(57) ABSTRACT

A wireless transmit receive unit (WTRU) may receive configuration information. The configuration information may comprise an indication of a number of views associated with a multiview canonical correlation analysis (CCA) transmission and/or a transmit power configuration associated with the multiview CCA transmission. The WTRU may determine, based on the number of views and the transmit power configuration associated with the multiview CCA transmission, a first transmit power value and/or a second power value. The first transmit power value may be associated with a first group of resource elements (REs) of the multiview CCA transmission that does not comprise repeated data. The second transmit power value may be associated with a second group of REs associated with the multiview CCA transmission that comprises repeated data. The multiview CCA transmission may comprise first data transmitted via the first group of REs and/or second data transmitted via the second group of REs.

### BACKGROUND

Factor analysis techniques are becoming more prominent in machine learning, data analytics and/or signal processing communities. For instance, principal component analysis (PCA), coupled matrix factorization (CMF), independent component analysis (ICA), and/or canonical correlation analysis (CCA), are widely used in compression, dimensionality reduction, visualization, and/or subspace estimation, to list a few. These techniques may operate in an unsupervised manner but under different objectives, depending on the considered application. These tools may aim at extracting latent components from one data view and/or matrix (e.g., PCA and/or ICA), while others aim to recover latent common information from multiple data views/matrices (e.g., CMF and/or CCA).

### SUMMARY

A wireless transmit receive unit (WTRU) may receive configuration information. The configuration information may comprise an indication of a number of views associated with a multiview canonical correlation analysis (CCA) transmission and/or a transmit power configuration associated with the multiview CCA transmission. The WTRU may determine, based on the number of views and the transmit power associated with the multiview CCA transmission, a first transmit power value and/or a second power value. The first transmit power value may be associated with a first group of resource elements (REs) of the multiview CCA transmission that does not comprise repeated data. The second transmit power value may be associated with a second group of REs associated with the multiview CCA transmission that comprises repeated data. The WTRU may transmit the multiview CCA transmission. The multiview CCA transmission may comprise first data transmitted via the first group of REs and/or second data transmitted via the second group of RE. The first data may be transmitted using the first transmit power value and/or the second data may be transmitted using the second transmit power value.

The first group of REs may be non-CCA symbols and the second group of REs may be CCA symbols. The second group of REs may comprise a plurality of subgroups of REs. The plurality of subgroups of REs may comprise a first subgroup of REs and a second subgroup of REs. The first subgroup of REs may comprise data. The second subgroup of REs may comprise one or more repeated versions of the data from the first subgroup of REs. The plurality of subgroups of REs comprise a third subgroup of RES, wherein the third subgroup of REs comprises correction reference symbols associated with the data comprised in the first subgroup of RES.

The WTRU may receive an uplink grant. The uplink grant may indicate a PUSCH format associated with the multiview CCA transmission.

The first transmit power value may be based on a first set of power control parameters and the number of views associated with the multiview CCA transmission. The first set of power control parameters may comprise one or more of a first CCA-based transmit power control (TPC) command, a first compensation loss parameter, or a modulation and coding scheme (MCS) parameter. The second transmit power value may be based on a second set of power control parameters. The second set of power control parameters may comprise a power offset relative to the first transmit power, a second CCA-based TPC command, and/or a second compensation loss parameter. The WTRU may determine a backoff value based on the number of views, wherein a power level associated with the first power transmit value is based on the backoff value.

The configuration information further comprises one or more of an indication of a repetition pattern type, wherein the repetition pattern type indicates uniform or non-uniform spacing between one or more REs of the second group of REs, an indication of a per-view repetition dimension, wherein the per-view repetition dimension indicates whether to perform repetition by time or by frequency, an indication of a per-view time span, wherein the per-view time span indicates how many OFDM symbols are in the time domain, an indication of a per-view frequency span, wherein the per-view time span indicates how many OFDM symbols are in the frequency domain, an indication of a PUSCH format, or an indication of a CCA phase correction RE format. The transmit power configuration associated with the multiview CCA transmission may comprise one or more of the first transmit power value, the second transmit power value, a mapping function associated with the number of views associated with the multiview CCA transmission, or a power offset between the first group of REs associated with PUSCH data REs that are not repeated in the first group of REs and/or the second group of REs associated with PUSCH data REs that are repeated in the second group of REs.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 depicts a PUSCH format with multiview CCA transmission.

FIG. 3 depicts a block diagram illustrating the steps of the multiview CCA based PUSCH transmission using the CCA specific power control commands.

### DETAILED DESCRIPTION

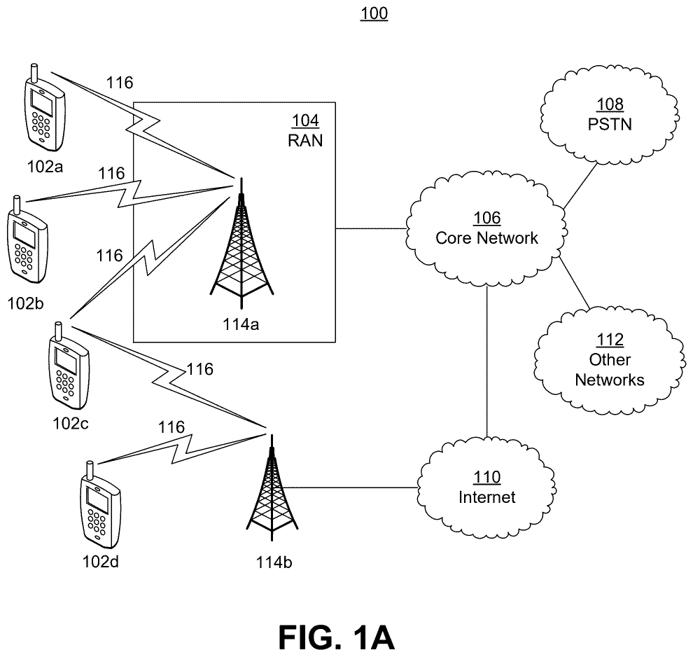

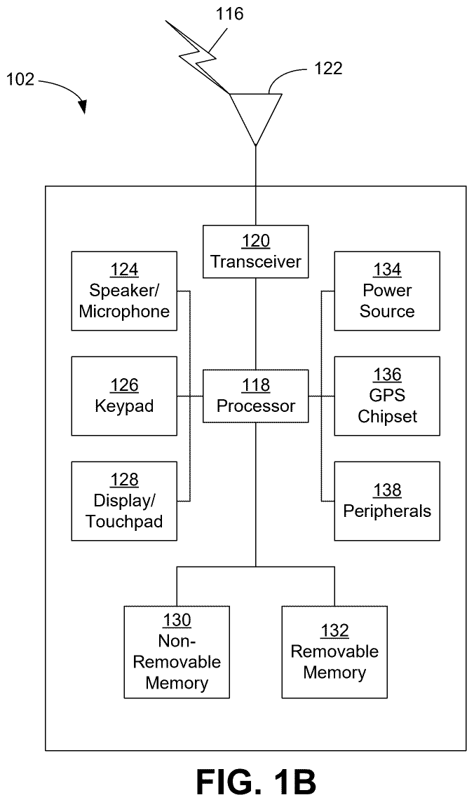

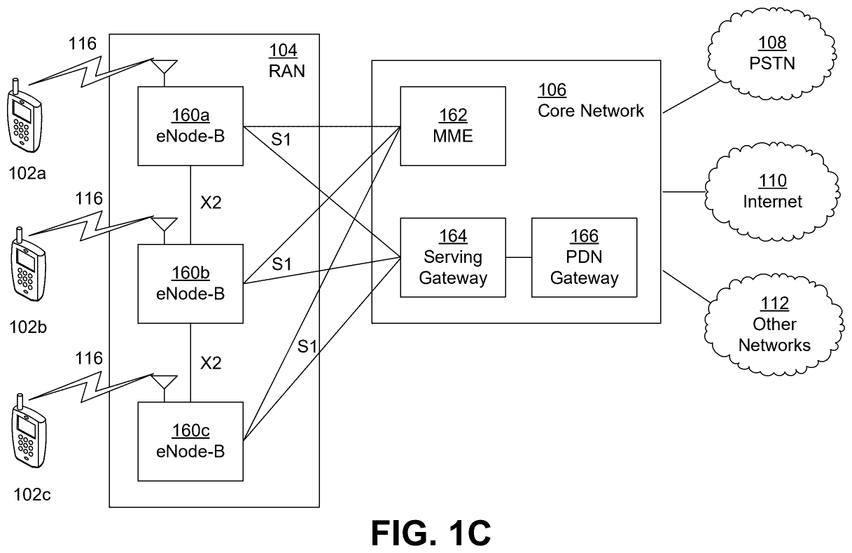

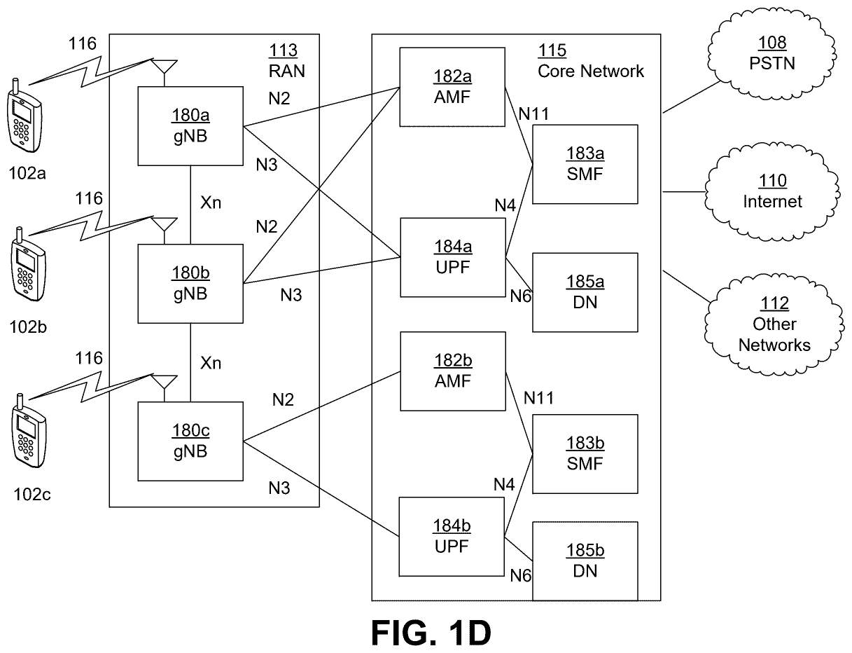

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other

STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Canonical correlation analysis (CCA) may be a powerful machine learning technique widely used in different fields, including machine learning and/or signal processing. CCA may be a multiview analysis technique that may discover latent common information between two data views. While single-view analysis techniques, like principal component analysis (PCA), aim at extracting strong components from the given data matrix, multiview analysis tools such as CCA may jointly analyze different views of the data. From an optimization perspective, CCA may be based on a “differential” criterion that forces CCA to focus on common features between the different views. If one of the views includes a very strong component that may be absent from the other view, then CCA may ignore principal components no matter how strong as long as they are not common. CCA may operate in either a linear fashion (referred to as linear CCA) or a non-linear fashion (referred to as Kernel CCA (KCCA), deep CCA (DCCA), and/or non-linear CCA). The main difference is that in linear CCA, the objective is to extract the latent common features through finding two linear projections of the given two data views. However, in the non-linear case, the projections may be generally non-linear (e.g., based on deep neural network (DNN)).

Different from CCA, multiview CCA or generalized CCA (GCCA) may operate on more than two views of data. GCCA may find M>2 vectors qₘ∈C^{N}^{ᵣ} (known as GCCA canonical vectors and referred to as GCCA combiners herein) such that the resulting N-dimensional components from the M projections

$${Y}_{m}^{T} {q}_{m} ∈ {ℂ}^{N}$$

are maximally correlated, where Yₘ∈ [symbol] are M given data views, Nᵣ represents the number of receive antennas, and N represents the number of data symbols or resource elements (REs) within a view, for m=1, . . . , M. In other words, GCCA aims to find a latent common representation, g∈C^{N}, using a linear combination of the M data views. In an optimization framework, the GCCA formulation is given as,

$${min}_{{q}_{m} \vert {‖ {g}^{T} g ‖}_{2}^{2} = 1} {\sum }_{m = 1}^{M} {‖ {Y}_{m}^{T} {q}_{m} - g ‖}_{2}^{2} \qquad ( 1 )$$

Expression (1) may provide a simple algebraic solution via eigenvalue decomposition. In particular, the overall complexity may require solving an eigenvalue decomposition of a matrix that involves M cross-correlation computations in addition to M matrix inversions.

Uplink power control may be one of the fundamental tasks required to enable efficient uplink communication between the WTRU and network. Uplink power control may involve coordination between the WTRU and network to determine the appropriate WTRU transmit power level needed to reliably decode its signal while not impacting the reception of the other WTRUs' signals. The WTRUs suffering from high path-loss (e.g., cell-edge users), may need to increase their power level, e.g., through adapting the path-loss compensating factor and/or the modulation and coding scheme (MCS) factor to ensure reliable reception. This may severely impact those WTRUs' power consumption and/or may result in quick depletion of the WTRU battery.

An example that may allow for low power transmission while ensuring reliable detection of the received signal is to use multiview learning at the receiver. Multiview learning using canonical correlation analysis (CCA) may reliably decode the desired signals without the need to perform channel estimation. The multiview learning approach may be used to replace the DMRS approach while providing gains in terms of performance, overhead reduction, power consumption, and/or complexity. The idea is that the WTRU may transmit multiple replicas of the transmitted signal at low power and/or the network (NW) leverages such a repetition structure by applying multiview CCA. The WTRU signal may be reliably recovered even at low signal to noise (SNR) and/or without channel estimation and/or demodulation reference signal (DMRS) transmission. Increasing the number of views and/or repetitions through using generalized CCA (GCCA) has a direct connection with power consumption. Increasing the number of views and/or repetitions may enable the transmitter to reduce its power level while ensuring a target detection performance. While adding more views may introduce more redundancy, they may eventually result in an enhanced recovery of the data, which in turn may result in better end-to-end performance. A key challenge regards how to control the uplink power as a function of the number of views and/or repetitions, and/or under what conditions the WTRU may increase the number of views.

The proposed framework may control, reduce, and/or optimize the uplink power while maintaining a target performance, (e.g., block error rate (BLER) level). Accordingly, the following problems are addressed: enabling multiview CCA-based PUSCH transmission and reception. Also addressed is the determination of the conditions and how the multiview PUSCH transmission may impact the uplink power control loop. Another problem addressed is how the WTRU may determine the uplink transmit power as a function of the multiview CCA parameters (e.g., number of views and/or repetitions).

Multiview learning using GCCA may optimize the WTRU power control cycle. Increasing the number of views and/or repetitions may allow the WTRU to transmit its signal at lower power while maintaining a predefined performance level, (e.g., BLER level), resulting in a more efficient use of the WTRU power. Methods are described for WTRU power optimization and/or adjustment based on multiview PUSCH transmission.

A WTRU may be configured with one or more parameters associated with multiview CCA transmission. The configuration may include a physical uplink shared channel (PUSCH) format (e.g., DMRS and/or multiview CCA) and/or layer-specific multiview CCA configuration. The layer-specific Multiview CCA configuration may be configured using one or more options, including but not limited to: number of views (M), which refers to default, min, and/or max values; repetition pattern type, e.g., uniform vs. non-uniform indicating the distance between every two consecutive views and/or distance from a reference point in the time frequency grid, distance from the first view wherein the first view location is predefined, and/or function of the size of the PUSCH allocation; per-view repetition dimension, e.g., first repetition in time and second repetition in frequency; per-view time span: additional position in time indicating how many orthogonal frequency divisional multiplexing (OFDM) symbols each view and/or repetition is spanning; per-view frequency span: additional position in frequency (e.g., every N resource blocks (RBs)).

A WTRU may be configured with CCA phase correction reference symbol format (e.g., number, locations, and/or modulation order, etc.). A WTRU may be configured with a transmit power configuration associated with multiview CCA transmission and/or including one or more of the following: comprising a first transmit power value for non-repeated PUSCH data and/or a second transmit power value for repeated PUSCH data; mapping function f(M) from number of views to power adjustment; power offset between the non-repeated and repeated data; first set of power control parameters and/or a second set of power control parameters, wherein some parameters may be shared across the two sets, (e.g., target base rx power, Rb factor, modulation and coding scheme (MCS) factor, and/or some parameters may be different across the two sets, (e.g., transmit power control (TPC) command and/or path loss (PL) compensation); and/or configured through radio resource control (RRC) or indicated in downlink control information (DCI).

The WTRU may receive an uplink (UL) grant. The UL grant may indicate a PUSCH format associated with multiview CCA transmission based on the set of configuration parameters.

The WTRU may determine a first transmit power value and/or a second transmit power value based on the transmit power configuration parameters and/or the configured number of views (M). The first transmit power value may be associated with the PUSCH data symbols not involved in repetition. The first transmit power value may be determined based on the configured first set of power control parameters, e.g., TPC and/or compensation loss associated with the first set and/or the number of views. The first transmit power value may be expressed as,

PTx₁=min(Pmax,P_{Target}+α₁PL+ƒ_{MCS}+ƒ_{Rb factor}+ƒ_{TPC}−ƒ(M))

The second transmit power value may be associated with the PUSCH data symbols involved in repetition. The second transmit power value may be determined based on the configured second set of power control parameters and/or the determined first transmit power value, e.g., TPC and compensation loss associated with the second set and/or the number of views, the second transmit power value may be expressed as,

PTx₂=min(Pmax,P_{Target}+α₂PL+ƒ_{MCS}+ƒ_{Rb factor}+ƒ_{TPC}−ƒ(M)), or PTx₂=PTx₁−power offset

The WTRU may transmit the PUSCH associated with multiview CCA transmission. The multiview CCA transmission may include: for each transmission layer, a set of symbols containing four groups of REs; a first group of REs carrying PUSCH data associated with a first layer; a second group of REs carrying one or more copied version of the PUSCH data belonging to the first group of REs associated with a first layer; a third group of REs carrying a CCA phase correction reference symbol associated with a first layer; and/or a fourth group of REs carrying PUSCH data not involved in data repetition and/or copying.

The multiview CCA transmission may further include the first three groups of REs, which may be transmitted using a second transmit power value associated with the second set of power control parameters. The multiview CCA transmission may further include the fourth group of REs, which may be transmitted using a first transmit power value associated with the first set of power control parameters. The multiview CCA transmission may further include a field in DCI to indicate the new PUSCH format with multiview CCA transmission.

The CCA may need two data views (e.g., M=2) for proper operation. GCCA may need M data views for proper operation, wherein M>2. A CCA view may be defined as a multi-antenna reception of a signal including a group of data REs in the time-frequency grid with some characteristics (e.g., enforced structure). The number of REs in all of the GCCA views may be the same for proper GCCA operation. The transmitted data across all views may be the same wherein the data symbols are copied from the first views to the remaining M−1 views, resulting in M−1 repetitions.

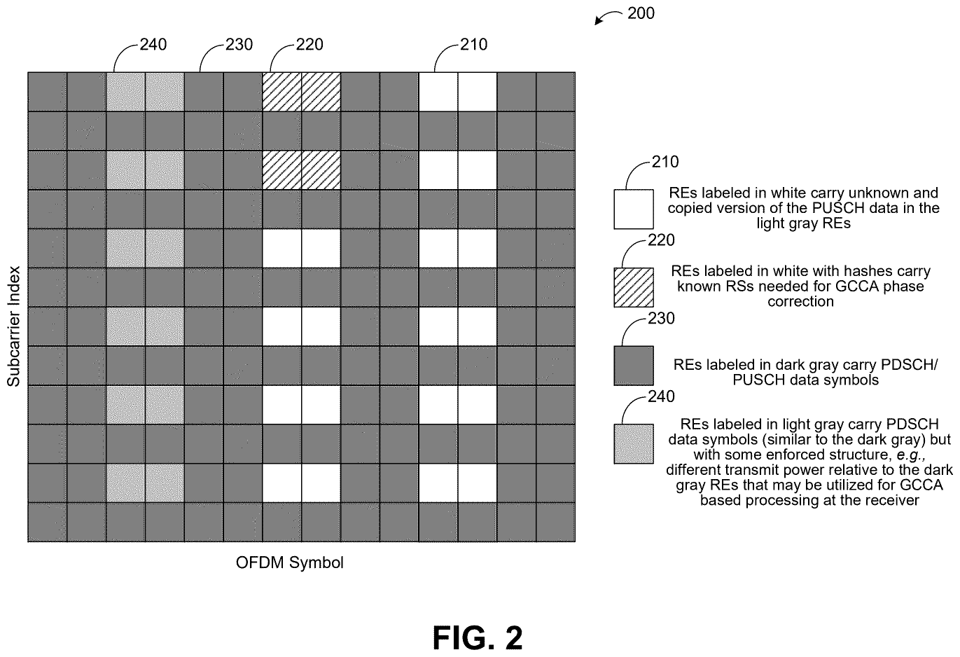

To enable proper GCCA operation, the WTRU may employ data (e.g., symbol and/or sample) repetition either in time or frequency or both. The WTRU may form the M views either in time or frequency depending on the repetition type. As seen in FIG. 2, each of the M groups of light-gray and white REs may form a GCCA view that may be used at the receiver for finding the equalizer and/or combiner without channel estimation. The terms “time and/or frequency” and “regular” may be used interchangeably to indicate that the repetition is employed in time and/or frequency.

FIG. 2 depicts a PUSCH format with multiview CCA transmission 200. REs labeled in white 210 carry unknown and copied version of the PUSCH data in the light gray REs. REs labeled in white with hashes 220 carry known RSs needed for GCCA phase correction. REs labeled in dark gray 230 carry PDSCH/PUSCH data symbols. REs labeled in light gray 240 carry PDSCH data symbols (similar to the dark gray) but with some enforced structure, e.g., different transmit power relative to the dark gray REs that may be utilized for GCCA based processing at the receiver.

Multiview and/or GCCA may employ symbol repetition either in time or frequency. The WTRU may form M views in time and/or frequency depending on the repetition type. Note that almost all symbols (except phase reference signals (RSs)) do not carry the RS; rather, they carry data. FIG. 2 shows an example of a single RB with GCCA transmission with M=3 views. The first view may contain a group of data REs 240 colored in light gray. The second view may contain a group of data REs 210 colored in white. The data REs 220 may represent a copy of the light-gray data REs 240. The third view may contains a group of data REs 210 colored in white and/or also represents a second copy of the light gray data REs 240. The receiver may use the three views for processing using GCCA to derive the GCCA combiners.

Data channel format description with multiview CCA transmission is described herein. The solution described herein is applicable to any physical channel, e.g., physical downlink shared channel (PDSCH), physical uplink shared channel (PUSCH), physical uplink control channel (PUCCH), physical uplink downlink control channel (PDCCH), physical broadcast channel (PBCH), physical random access channel (PRACH), and/or any side link channels, etc. For example, some solutions may incorporate PUSCH, but the solutions are equally applicable to any other physical channel. For example, some solutions may describe the NW as receiver of multiview CCA transmission, but the solutions are equally applicable for the case of NW as a transmitter of multiview transmission. Herein, the terms multiview CCA and generalized CCA may be used interchangeably to indicate more than two views (e.g., M>2) are utilized in the decoding process.

The format of the data channel with multiview CCA transmission may be fundamentally different from the DMRS-based transmission. In the DMRS based data channel, the known DMRS may be sent in different resources from the data. The DMRS may then be used at the receiver to estimate the effective channel, interpolate and/or extrapolate the estimated channel at the DMRS location to obtain the channel at all other REs, design the equalizer as a function of the channel, and/or then use the derived equalizers to decode the desired symbols. The data channel with multiview based transmission may not include DMRS transmission as shown in FIG. 2. The data channel may not require channel estimation at the receiver. Rather, the data channel may require employing a simple repetition-based transmission scheme at the transmitter coupled with GCCA-based decoding at the receiver. In addition, for multiuser and/or multilayer transmission, the same layers and/or users may share the same resources for data repetition as long as the repetition patterns are different across the users and/or layers. This results in a much more relaxed constraint compared to the DMRS approach which requires the reference symbols to be orthogonal across layers and/or users with any loss in orthogonality may be severely impacting the performance.

For PUSCH transmission, the WTRU may be configured with one or more parameters for the PUSCH transmission based on the multiview CCA transmission. The WTRU may be indicated with the locations of the data REs involved in the repetition, light-gray data REs 240 as shown in FIG. 2. The WTRU may be configured with a first offset and/or a second offset. The first offset may indicate the location of the data symbols in the second view relative to the first view. The second offset may indicate the location of the data symbols in the third view relative to the first/second view. The WTRU may be configured with the view density indicating the number of REs within a view, wherein the number of REs in all views should be the same. The WTRU may be configured with a few reference symbols to resolve the phase ambiguity. The number of phase symbols for phase ambiguity resolution may be as small as one symbol in the moderate to high SNR scenarios and may go up to a few symbols (e.g., 4 symbols), in the low SNR scenarios.

Herein described are multiview CCA specific power control configuration parameters for multiview CCA based PUSCH transmission. For PUSCH transmission, the WTRU may be configured with power commands specific to multiview CCA transmission. The power control commands may include a specific CCA-based transmit power control command (TPC) tied to the number of views parameters. For example, the configured TPC command may include an implicit indication of the number of views. The WTRU may be configured with a power control offset command indicating the power difference between the data transmitted in the views locations and the data transmitted outside the views locations. The WTRU may be transmitted with two MCS factors for adjusting the transmit power, a first MCS factor associated with the data transmitted in the views locations and a second MCS factor associated with the data transmitted outside the views locations. The two configured MCS factors associated with the power control may be used as an implicit indication of the number of views for multiview CCA transmission.

Herein described is reception and/or processing of data channel with multiview and/or generalized CCA transmission. As an example of decoding the data channel with multiview CCA transmission, consider the PUSCH format with the multiview CCA transmission shown in FIG. 2, the received signal, Yᵢ, associated with the i-th view, corresponding to the transmitted data REs 210 and 240 (colored in white and light gray, respectively), denoted as x∈C^{N} can be expressed as

Yᵢ=hᵢx^{T}+Wᵢ

where Yᵢ∈C^{N}^{ᵣ}^{×N} is the received multi-antenna signal associated with the i-th at the receiver, hᵢ∈C^{N}^{ᵣ} is the effective and/or precoded channel associated with the i-th view and Wᵢ∈C^{N}^{ᵣ}^{×N} denotes the noise term associated with the i-th view, i=1, . . . , M. The parameter N defines the GCCA view length/density, (e.g., N=12 in FIG. 2). Hereafter, N may be referred to as the GCCA view length or density. There are no assumptions on the channel vectors associated with the different views. The channel vectors hᵢ may be identical or orthogonal. Once the M views are constructed, the following problem can be solved using the signals Yᵢ,

$${min}_{{q}_{m} \vert {‖ {g}^{T} g ‖}_{2}^{2} = 1} {\sum }_{m = 1}^{M} {‖ {Y}_{m}^{T} {q}_{m} - g ‖}_{2}$$

wherein ∥⋅∥_{F} denotes the Frobenius norm. The vectors qₘ, m=1, . . . , M, represent the combiner associated with decoding the signal of interest (common signal) from the m-th view. The vector g denotes the signal of interest, which is under ideal conditions, i.e., without noise, should be expressed as,

g=αx
wherein α is a complex phase ambiguity which may be easily resolved using the transmitted CCA reference symbols for phase correction. In case of noise, the vector g will be a noisy version of the transmitted signal x. Since the same signal can be obtained from different views but with different noise term, the different common signals obtained from different views may be efficiently combined to further reduce the noise and improve recovery of the symbols associated with the different GCCA views. Once the combiners are obtained, each combiner qₘ can be applied to recover the data symbols in the neighborhood of the respective view Yₘ. In a solution, interpolation and/or extrapolation techniques may estimate the combiners associated with the other data REs.

Herein described the configuration of PUSCH with multiview CCA transmission. A WTRU with multiview CCA transmission capability may receive configuration for multiview CCA based uplink data channel transmission. The WTRU may optimize the multiview CCA transmission to optimize the WTRU transmit power, (e.g., for cell-edge WTRUs). The configuration may include the format of the UL data channel (e.g., reference signal based or CCA based), layer specific multiview CCA configuration, CCA phase correction parameters, and/or transmit power configuration for the multiview CCA transmission.

The WTRU may receive configuration for the UL data channel format, for example for reference signal-based transmission (e.g., PUSCH using DMRS) or for CCA-based transmission (e.g., a PUSCH mapping without DM-RS). The UL data channel format configuration may be semi-static (e.g., via RRC) or dynamic (e.g., via DCI).

The WTRU may receive layer specific multiview CCA configuration. The configuration may include one or more of the following: number of views (M); the WTRU may receive configuration for the minimum, maximum and/or a default number of views, where the minimum number of views may be greater to or equal to 2 (e.g., Mₘᵢₙ≥2). The WTRU may assume regular CCA operation, for example, when the maximum number of views is configured as Mₘₐₓ=2. Alternatively, the WTRU may be configured with the number of repetitions, where the number of repetitions may be equal to the number of views minus 1. The WTRU may be configured with a minimum, maximum and/or a default number of repetitions. If the maximum number of repetitions is configured as 1, the WTRU may assume regular CCA operation, otherwise it assumes multiview operation.

The configuration may include a configuration for the time-frequency location of the first view (e.g., the original view) with respect to a reference point in the time-frequency grid. The configuration may include a repetition type. This parameter may indicate whether the views are repeated in time domain (e.g., across OFDM symbols), or in frequency domain (e.g., across sub-carriers or RBs).

The configuration may include pattern repetition type: this parameter may indicate uniform or non-uniform spacing between consecutive views. For example, when the WTRU is configured with uniform pattern repetition type, the WTRU may receive configuration for the distance between two consecutive views, where the distance may be expressed in OFDM symbols (e.g., when time-domain repetition is configured), or the distance may be expressed in number of sub-carriers or number of RBs (e.g., when frequency-domain repetition is configured). When the WTRU is configured for non-uniform pattern repetition type, the WTRU may receive configuration for the time-frequency location of each repeated view with respect to the first view (e.g., the original view).

The configuration may include per-view repetition dimension: this may be set to “time-first” or “frequency-first.” The parameter may indicate the dimension across which the first repetition of the original view is performed. For example, when the “per-view repetition dimension” parameter is set to “time-first”, the first repetition of the original view may be performed in time-domain, the second repetition may be performed in frequency-domain, and subsequent repetitions up to the configured M−1 number of repetitions alternate from time-domain to frequency-domain. In another example, when the “per-view repetition dimension” parameter is set to “frequency-first”, the first repetition of the original view is performed in frequency-domain, the second repetition is performed in time-domain, and/or subsequent repetitions up to the configured M−1 number of repetitions alternate from frequency-domain to time-domain. The WTRU may be configured with multiple (e.g., more than one) original views per RB or per sub-band, or per group of RBs. In this case, the WTRU may receive configuration for the “per-view repetition dimension” parameter for each of the configured original views.

The configuration may include per-view time span: this parameter may indicate how many OFDM symbols each view (e.g., original or repetition) spans in time domain. The configuration may include per-view frequency span: this parameter may indicate the span in frequency domain for each view (e.g., original or repetition). For example, in frequency domain, the views may span a number of sub-carriers within the same RB, or the views may span sub-carriers across multiple RBs.

The WTRU may receive configuration for the CCA phase correction parameters, where the configuration may include one or more of the following: number of reference symbols per view for CCA phase correction purposes (e.g., CCA phase correction symbols); location of each CCA phase correction symbol, where the location may be indicated relative to a time-frequency reference resource element (RE); (for example, the reference RE may be the RE with the smallest sub-carrier index and smallest OFDM symbol number of the first (e.g., original) view); and/or the modulation order for the CCA phase correction symbol.

The WTRU may receive configuration for the transmit power for the multiview CCA transmission, where the configuration may include one or more of the following: a first transmit power value for the non-repeated REs; (for example, when the multiview

CCA transmission is used for the UL data channel, the first transmit power value may be associated with the non-repeated PUSCH data); a second transmit power value for the repeated data.

The configuration for the transmit power for the multiview CCA transmission may include a mapping function, ƒ(M), for the transmit power adjustment as a function of the number of views. The WTRU may use the mapping function, for example, to back off the transmit power as a function of the number of views. The WTRU may receive an index within a set of mapping functions, e.g., when several mapping functions are pre-defined.

The configuration for the transmit power for the multiview CCA transmission may further include: a power offset between the non-repeated and the repeated data; a first set of power control parameters associated with the data (e.g., REs) not included in the repetition, where the power control parameters may include: target power, path loss compensation factor, Rb factor, MCS factor, and/or TPC. The configuration may further include a second set of power control parameters associated to the data (e.g., REs) included in the repetition, for example target power, path loss compensation factor, Rb factor, MCS factor, and/or TPC. For example, some of the power control parameters may be the same for the first and second set, e.g., target power, Rb factor, and/or MCS factor, while other power control parameters may be different between the first and/or second set.

A WTRU with multiview CCA transmission capability may receive a first UL grant. The UL grant may indicate a first PUSCH format associated with multiview CCA transmission based on a first set of configuration parameters. The WTRU may receive configurations through RRC or indicated with DCI wherein the configurations may include, e.g., maximum power (Pmax), target power (P_{Target}), path loss compensation factor (α₁), Rb factor (ƒ_{RB factor}), MCS factor (ƒ_{MCS factor})), TPC (ƒ_{TPC}), number of views (M), a mapping function ƒ(M), and/or power offset value. The WTRU may receive a second set of transmit power control parameters wherein some parameters may be different than the first set of transmit power control parameters, e.g., TPC (ƒ′_{TPC}) and path loss factor (α₂).

The WTRU may determine a first transmit power value based on the received first set of configurations wherein the first transmit power value may be associated with the PUSCH data symbols not involved in repetition. The first transmit power value may be determined based on a first set of power control parameters as follows; e.g., the first transmit power value may be expressed as,

PTx₁=min(Pmax,P_{Target}+α₁PL+ƒ_{MCS}+ƒ_{Rb factor}+ƒ_{TPC}−ƒ(M)

The WTRU may determine a power backoff value based on the number of views, e.g., ƒ(M), for further power adjustment. The power backoff value ƒ(M) may be a function, e.g., a mapping function to compute a power backoff value given the value of M. For example, the mapping function may be expressed as ƒ(M), =10 log₁₀(M). For the function ƒ(M), each WTRU may use its own mapping table. The WTRU may use a mapping table configured by the NW. In another solution, the WTRU may use a AIML model to determine the power backoff value for a given M and power control configurations.

The WTRU may determine a second transmit power value based on a second set of power control parameters associated with PUSCH symbols involved in repetition wherein some parameters may be different from the first set of power control parameters, e.g., TPC

$$( {f}_{TPC}^{′}$$

and path loss factor (α₂).

In a solution, the second transmit power value may be determined based on a second set of power control parameters as follows.

$${PTx}_{2} = min ( P max , {P}_{Target} + {α}_{2} PL + {f}_{MCS} + {f}_{Rb factor} + {f}_{TPC}^{′} - f ( M ) )$$

PTx₂ may be different from PTx₁ due to different transmit power control parameters. The mapping table ƒ(M) may be different from the mapping table used in the computation of PTx₁. The WTRU may use a AIML model to determine the power backoff value for a given M and/or power control configurations for the second transmit power value.

In another solution, the second transmit power value may be determined based on a power offset relative to PTx₁ as follows,

PTx₂=PTx₁−power offset

The power offset may be a fixed positive value configured by the NW. The power offset value may be negative or positive based on the measurement on received signal. If the received signal strength or signal to noise ratio is higher than a threshold, then the WTRU may be configured to use a negative power offset. Otherwise the WTRU may use a negative power offset value. The WTRU may determine the power offset value using an AIML model wherein the inputs are, e.g., power control parameters and number of views. The WTRU may determine the first transmit power associated with the non-repeated data based on NW configuration and/or the second transmit power associated with the repeated data based on NW configuration.

Described herein are PUSCH transmission(s) based on updated and/or power control parameters. The WTRU may determine a parameter for PUSCH transmission as a function of CCA configuration associated with that transmission. The WTRU may determine transmit power for PUSCH as a function of number of CCA views.

The WTRU may receive an UL grant in DCI, wherein the DCI may indicate explicitly or implicitly that the CCA based PUSCH transmission be performed on the UL grant. The DCI may explicitly or implicitly indicate at least one parameter and/or configuration associated with CCA transmission. The DCI may explicitly indicate that the PUSCH is associated with multiview CCA transmission. For example, DCI may carry a Boolean indication to differentiate from legacy transmission and CCA transmission. In another example, DCI may carry an indication of number of CCA views for PUSCH transmission. The DCI may indicate the format, size and/or time and/or frequency location of CCA phase correction reference symbol. The DCI may indicate the format, size and/or time and/or frequency location of CCA symbols.

The DCI may implicitly indicate the PUSCH associated with multiview CCA transmission. For example, the WTRU may be configured to monitor a first RNTI and/or a second RNTI. The DCI scrambled with first RNTI may indicate legacy PUSCH and/or DCI scrambled with second RNTI may indicate PUSCH associated with CCA transmission. A new DCI format may be defined to carry CCA configuration. In a solution, the WTRU may be configured with plurality of CCA configuration sets in RRC signaling. The DCI may indicate an identity associated with specific CCA configuration from the plurality of preconfigured sets. The DCI may indicate a scaling factor that should be applied for power control for transmission CCA symbols. The DCI may indicate a first and a second scaling factor where the first scaling factor may be applied for determining transmit power for first subset of REs and/or a second scaling factor may be applied for determining transmit power for a second subset of REs. The DCI may indicate common CCA configuration for all (MIMO) transmission layers. In another solution, the DCI may indicate CCA configuration specific to each (MIMO) transmission layer. The RRC signaling may indicate a common CCA configuration for all layers and DCI may indicate CCA configuration specific to each (MIMO) transmission layer.

The WTRU may receive semi-statically configured grants allocating resources for UL transmission. For example, the configured grant may indicate multiview CCA transmission parameters. The WTRU may receive an activation command for configured grants wherein the activation command may indicate one or more of the following: the number of CCA views, power control scaling factor, RE grouping, format, size and/or time and/or frequency resources occupied by CCA symbols, possibly one or more of the configurations may be layer specific. The WTRU may receive MAC CE carrying updates to one or more configuration aspects of multiview CCA transmission.

The WTRU may transmit PUSCH associated with multiview CCA transmission. In a solution, the multiview CCA transmission may include one or more groups of REs. Possibly such RE grouping may be configured to be (MIMO) transmission layer specific. A first group of REs may carry PUSCH data associated with the first layer. A second group of REs may carry one or more copied version of PUSCH data belonging to the first group of REs associated with a first layer. For a CCA configuration with two views, the PUSCH data may be repeated once (one original data and another repeated version). For CCA configuration with three views, the PUSCH data may be repeated twice (e.g., one original data and two repeated versions) and so on. A third group of REs may carry CCA phase correction reference symbol associated with first layer. The CCA phase correction reference symbol may be configured as DMRS. A fourth group of REs may carry PUSCH data not involved in data repetition and/or copying. In a more general solution with n-views, the WTRU may be configured with n−1 sets of second group of REs. Each set of the second group of REs may correspond to a different view.

The WTRU may transmit different RE groups with different transmit powers. The WTRU may derive the transmit power value based on preconfigured rules. The WTRU may determine the transmit power based on number of configured CCA views. The first three groups of REs may be transmitted using a first transmit power value associated with the first set of power control parameters. The fourth group of REs may be transmitted using a second transmit power value associated with the second set of power control parameters. The WTRU may receive a first set of power control commands and/or a second set of power control commands. The WTRU may apply the first set of power control commands for CCA transmissions and/or second set of power control commands for non-CCA transmissions.

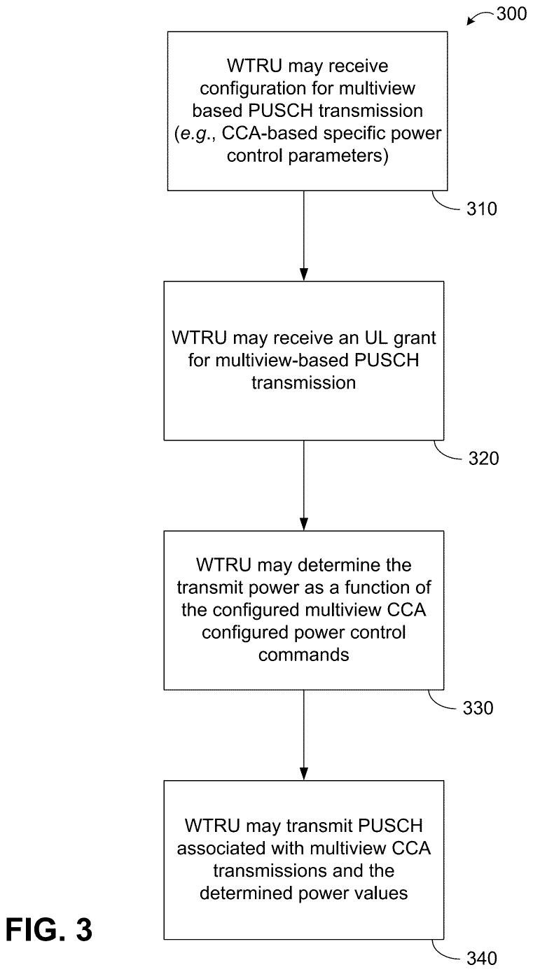

FIG. 3 depicts a block diagram 300 illustrating the steps of the multiview CCA based PUSCH transmission using the CCA specific power control commands.

At 310, the WTRU may be configured with one or more parameters associated with multiview CCA transmission. The configuration may include a physical uplink shared channel (PUSCH) format (e.g., DMRS and/or multiview CCA) and/or layer-specific multiview CCA configuration. The layer-specific Multiview CCA configuration may be configured using one or more options, including but not limited to: number of views (M), which refers to default, min, and/or max values; repetition pattern type, e.g., uniform vs. non-uniform indicating the distance between every two consecutive views and/or distance from a reference point in the time frequency grid, distance from the first view wherein the first view location is predefined, and/or function of the size of the PUSCH allocation; per-view repetition dimension, e.g., first repetition in time and second repetition in frequency; per-view time span: additional position in time indicating how many orthogonal frequency divisional multiplexing (OFDM) symbols each view and/or repetition is spanning; per-view frequency span: additional position in frequency (e.g., every N resource blocks (RBs)).

A WTRU may be configured with CCA phase correction reference symbol format (e.g., number, locations, and/or modulation order, etc.). A WTRU may be configured with a transmit power configuration associated with multiview CCA transmission and/or including one or more of the following: comprising a first transmit power value for non-repeated PUSCH data and/or a second transmit power value for repeated PUSCH data; mapping function f(M) from number of views to power adjustment; power offset between the non-repeated and repeated data; first set of power control parameters and/or a second set of power control parameters, wherein some parameters may be shared across the two sets, (e.g., target base rx power, Rb factor, modulation and coding scheme (MCS) factor, and/or some parameters may be different across the two sets, (e.g., transmit power control (TPC) command and/or path loss (PL) compensation); and/or configured through radio resource control (RRC) or indicated in downlink control information (DCI).

At 320, the WTRU may receive an uplink (UL) grant. The UL grant may indicate a PUSCH format associated with multiview CCA transmission based on the set of configuration parameters.

At 330, the WTRU may determine a first transmit power value and/or a second transmit power value based on the transmit power configuration parameters and/or the configured number of views (M). The first transmit power value may be associated with the PUSCH data symbols not involved in repetition. The first transmit power value may be determined based on the configured first set of power control parameters, e.g., TPC and/or compensation loss associated with the first set and/or the number of views. The first transmit power value may be expressed as,

PTx₁=min(Pmax,P_{Target}+α₁PL+ƒ_{MCS}+ƒ_{Rb factor}+ƒ_{TPC}−ƒ(M)

The second transmit power value may be associated with the PUSCH data symbols involved in repetition. The second transmit power value may be determined based on the configured second set of power control parameters and/or the determined first transmit power value, e.g., TPC and compensation loss associated with the second set and/or the number of views, the second transmit power value may be expressed as,

PTx₂=min(Pmax,P_{Target}+α₂PL+ƒ_{MCS}+ƒ_{Rb factor}+ƒ_{TPC}−ƒ(M)), or PTx₂=PTx₁−power offset

At 340, the WTRU may transmit the PUSCH associated with multiview CCA transmission. The multiview CCA transmission may include: for each transmission layer, a set of symbols containing four groups of REs; a first group of REs carrying PUSCH data associated with a first layer; a second group of REs carrying one or more copied version of the PUSCH data belonging to the first group of REs associated with a first layer; a third group of REs carrying a CCA phase correction reference symbol associated with a first layer; and/or a fourth group of REs carrying PUSCH data not involved in data repetition and/or copying.

The multiview CCA transmission may further include the first three groups of REs, which may be transmitted using a second transmit power value associated with the second set of power control parameters. The multiview CCA transmission may further include the fourth group of REs, which may be transmitted using a first transmit power value associated with the first set of power control parameters. The multiview CCA transmission may further include a field in DCI to indicate the new PUSCH format with multiview CCA transmission.

What is claimed is:

1. A wireless transmit receive unit (WTRU) comprising:
a processor and memory, the processor configured to:
receive configuration information, wherein the configuration information comprises an indication of a number of views associated with a multiview canonical correlation analysis (CCA) transmission and a transmit power configuration associated with the multiview CCA transmission;
determine, based on the number of views and the transmit power configuration associated with the multiview CCA transmission, a first transmit power value and a second power value, wherein the first transmit power value is associated with a first group of resource elements (REs) of the multiview CCA transmission that does not comprise repeated data, and wherein the second transmit power value is associated with a second group of REs associated with the multiview CCA transmission that comprises repeated data; and
transmit the multiview CCA transmission, wherein the multiview CCA transmission comprises first data transmitted via the first group of REs and second data transmitted via the second group of REs, wherein the first data is transmitted using the first transmit power value and the second data is transmitted using the second transmit power value.

2. The WTRU of claim 1, wherein the first group of REs are non-CCA symbols and the second group of REs are CCA symbols.

3. The WTRU of claim 1, wherein the second group of REs comprises a plurality of subgroups of REs, wherein the plurality of subgroups of REs comprises a first subgroup of REs and a second subgroup of REs, wherein the first subgroup of REs comprises data, and the second subgroup of REs comprises one or more repeated version of the data from the first subgroup of REs.

4. The WTRU of claim 3, wherein the plurality of subgroups of REs comprise a third subgroup of REs, wherein the third subgroup of REs comprises phase correction reference symbols associated with the data comprised in the second group of REs.

5. The WTRU of claim 1, the processor further configured to:
receive an uplink grant, wherein the uplink grant indicates a PUSCH format associated with the multiview CCA transmission.

6. The WTRU of claim 1, wherein the first transmit power value is based on a first set of power control parameters and the number of views associated with the multiview CCA transmission, and wherein the first set of power control parameters comprises one or more of a first CCA-based transmit power control (TPC) command, a first compensation loss parameter, or a modulation and coding scheme (MCS) parameter.

7. The WTRU of claim 6, wherein the second transmit power value is based on a second set of power control parameters, wherein the second set of power control parameters comprise a power offset relative to the first transmit power, a second CCA-based TPC command, or a second compensation loss parameter.

8. The WTRU of claim 1, wherein the processor is further configured to:
determine a backoff value based on the number of views, wherein α power level associated with the first power transmit value is based on the backoff value.

9. The WTRU of claim 1, wherein the configuration information further comprises one or more of an indication of a repetition pattern type, wherein the repetition pattern type indicates uniform or non-uniform spacing between one or more REs of the second group of REs, an indication of a per-view repetition dimension, wherein the per-view repetition dimension indicates whether to perform repetition by time or by frequency, an indication of a per-view time span, wherein the per-view time span indicates how many OFDM symbols are in the time domain, an indication of a per-view frequency span, wherein the per-view time span indicates how many OFDM symbols are in the frequency domain an indication of a PUSCH format, or an indication of a CCA phase correction RE format.

10. The WTRU of claim 1, wherein the transmit power configuration associated with the multiview CCA transmission comprises one or more of the first transmit power value, the second transmit power value, a mapping function associated with the number of views associated with the multiview CCA transmission, or a power offset between the first group of REs associated with PUSCH data REs that are not repeated in the first group of REs and the second group of REs associated with PUSCH data REs that are repeated in the second group of REs.

11. A method implemented by a wireless transmit receive unit (WTRU), the method comprising:
receiving configuration information, wherein the configuration information comprises an indication of a number of views associated with a multiview canonical correlation analysis (CCA) transmission and a transmit power configuration associated with the multiview CCA transmission;
determining, based on the number of views and the transmit power configuration associated with the multiview CCA transmission, a first transmit power value and a second power value, wherein the first transmit power value is associated with a first group of resource elements (REs) of the multiview CCA transmission that does not comprise repeated data, and wherein the second transmit power value is associated with a second group of REs associated with the multiview CCA transmission that comprises repeated data; and
transmitting the multiview CCA transmission, wherein the multiview CCA transmission comprises first data transmitted via the first group of REs and second data transmitted via the second group of REs, wherein the first data is transmitted using the first transmit power value and the second data is transmitted using the second transmit power value.

12. The method of claim 11, wherein the first group of REs are non-CCA symbols and the second group of REs are CCA symbols.

13. The method of claim 11, wherein the second group of REs comprises a plurality of subgroups of REs, wherein the plurality of subgroups of REs comprises a first subgroup of REs and a second subgroup of REs, wherein the first subgroup of REs comprises data, and the second subgroup of REs comprises one or more repeated versions of the data from the first subgroup of REs.

14. The method of claim 13, wherein the plurality of subgroups of REs comprise a third subgroup of REs, wherein the third subgroup of REs comprises phase correction reference symbols associated with the data comprised in the second group of REs.

15. The method of claim 11, the processor further configured to:
receiving an uplink grant, wherein the uplink grant indicates a PUSCH format associated with the multiview CCA transmission.

16. The method of claim 11, wherein the first transmit power value is based on a first set of power control parameters and the number of views associated with the multiview CCA transmission, and wherein the first set of power control parameters comprises one or more of a first CCA-based transmit power control (TPC) command, a first compensation loss parameter, or a modulation and coding scheme (MCS) parameter.

17. The method of claim 16, wherein the second transmit power value is based on a second set of power control parameters, wherein the second set of power control parameters comprise a power offset relative to the first transmit power, a second CCA-based TPC command, or a second compensation loss parameter.

18. The method of claim 11, wherein the processor is further configured to:
determining a backoff value based on the number of views, wherein α power level associated with the first power transmit value is based on the backoff value.

19. The method of claim 11, wherein the configuration information further comprises one or more of an indication of a repetition pattern type, wherein the repetition pattern type indicates uniform or non-uniform spacing between one or more REs of the second group of REs, an indication of a per-view repetition dimension, wherein the per-view repetition dimension indicates whether to perform repetition by time or by frequency, an indication of a per-view time span, wherein the per-view time span indicates how many OFDM symbols are in the time domain, an indication of a per-view frequency span, wherein the per-view time span indicates how many OFDM symbols are in the frequency domain an indication of a PUSCH format, or an indication of a CCA phase correction RE format.

20. The method of claim 11, wherein the transmit power configuration associated with the multiview CCA transmission comprises one or more of the first transmit power value, the second transmit power value, a mapping function associated with the number of views associated with the multiview CCA transmission, or a power offset between the first group of REs associated with PUSCH data REs that are not repeated in the first group of REs and the second group of REs associated with PUSCH data REs that are repeated in the second group of REs.
